(19) United States
(12) Patent Application Publication
(10) Pub. No.: US 2019/0383300 A1
(43) Pub. Date: Dec. 19, 2019

(54) VACUUM PUMP

(71) Applicant: SHIMADZU CORPORATION, Kyoto (JP)

(72) Inventors: Masashi MANABE, Kyoto (JP); Hidefumi SAITO, Kyoto (JP)

(21) Appl. No.: 16/401,885

(22) Filed: May 2, 2019

(30) Foreign Application Priority Data
Jun. 14, 2018 (JP) 2018-113743

(51) Int. Cl. F04D 29/063; F04D 19/04; F04D 29/059; F16C 33/66; F16N 7/12

(52) U.S. Cl. CPC F04D 29/063; F04D 19/042; F16C 2360/45; F16C 33/6659; F16N 7/12; F04D 29/059

(57) ABSTRACT

A vacuum pump comprises: a rolling bearing configured to support a rotor shaft provided at a pump rotor; a lubrication fluid storage section configured to store lubrication fluid supplied to the rolling bearing; a MEMS element including an infinitesimal flow rate pump configured to transfer the lubrication fluid of the lubrication fluid storage section to the rolling bearing; and a first flow path of a capillary structure configured to move the lubrication fluid of the lubrication fluid storage section to the infinitesimal flow rate pump by capillary force.

### BACKGROUND OF THE INVENTION

### 1. Technical Field

The present invention relates to a vacuum pump.

### 2. Background Art

Typically, a vacuum pump configured such that a rotor is supported by a rolling bearing has been known (see, e.g., Patent Literature 1 (Japanese Patent No. 6162644). The vacuum pump described in Patent Literature 1 is a turbo-molecular pump, and a higher rotation speed is necessary for a smaller turbo-molecular pump having a smaller rotor blade diameter. In the rolling bearing used for high-speed rotation, an optimal lubricant supply amount is extremely small.

Typically, it is, as in the technique described in Patent Literature 1, configured such that a cone having a conical surface is attached to an axial end side of the bearing and lubricant is supplied little by little from a flexible lubricant outflow section contacting the conical surface of the cone. The lubricant adhering to the conical surface moves to a bearing side with an increased cone diameter by centrifugal force, and then, flows into the bearing. In the technique described in Patent Literature 1, an outlet of a lubricant flow path is closed with a flexible core to serve as the lubricant outflow section. The lubricant is supplied to the core by the pump, thereby causing the core to contact the conical surface of the cone. The lubricant transferred in the core is sent to the conical surface of the cone by capillary action.

However, there is a disadvantage that the state of contact of the core with the conical surface changes due to an error in assembly of the core with the conical surface of the cone and the amount of lubricant to be supplied changes due to the contact state. Moreover, there is a problem that supply of the lubricant is insufficient due to deterioration caused by, e.g., core friction due to contact with the conical surface.

### SUMMARY OF THE INVENTION

A vacuum pump comprises: a rolling bearing configured to support a rotor shaft provided at a pump rotor; a lubrication fluid storage section configured to store lubrication fluid supplied to the rolling bearing; a MEMS element including an infinitesimal flow rate pump configured to transfer the lubrication fluid of the lubrication fluid storage section to the rolling bearing; and a first flow path of a capillary structure configured to move the lubrication fluid of the lubrication fluid storage section to the infinitesimal flow rate pump by capillary force.

The MEMS element is fixed to an outer peripheral surface of an outer ring of the rolling bearing, and a second flow path formed from an outer peripheral side to an inner peripheral side of the outer ring of the rolling bearing and configured to guide the lubrication fluid sent out of the infinitesimal flow rate pump to the inner peripheral side of the outer ring is provided.

The second flow path is a through-hole penetrating from the outer peripheral surface to an inner peripheral surface of the outer ring.

The MEMS element is fixed to an outer peripheral side of a holding section configured to hold the outer ring of the rolling bearing, and a second flow path formed from the outer peripheral side of the holding section to an inner peripheral side of the outer ring and configured to guide the lubrication fluid sent out of the infinitesimal flow rate pump to the inner peripheral side of the outer ring.

The vacuum pump further comprises: at least any one of a vibration sensor configured to detect vibration of the rolling bearing or a temperature sensor configured to detect a temperature of the rolling bearing; and a control section configured to drivably control the infinitesimal flow rate pump based on a detection result of the vibration sensor or the temperature sensor, thereby controlling an amount of the lubrication fluid to be transferred by the infinitesimal flow rate pump.

The vacuum pump further comprises: a warning section configured to output deterioration information on the rolling bearing based on the detection result of the vibration sensor or the temperature sensor.

The vacuum pump further comprises: a flow rate sensor configured to detect an amount of the lubrication fluid to be transferred by the infinitesimal flow rate pump; and a diagnosis section configured to make a diagnosis on an amount of the lubrication fluid stored in the lubrication fluid storage section based on a detection result of the flow rate sensor.

According to the present invention, a proper amount of lubrication fluid can be stably supplied to a rolling bearing rotating at high speed in vacuum environment.

### BRIEF DESCRIPTION OF THE DRAWINGS

FIG. 1 is a sectional view of a pump main body of a turbo-molecular pump;

FIG. 2 is a view for describing one example of a lubrication system of a bearing;

FIG. 3 is a perspective view of the bearing provided at a shaft;

FIG. 4 is a view of a lubrication fluid outflow side of a MEMS element;

FIGS. 5A and 5B are views of an A-A section of FIG. 4;

FIGS. 6A and 6B are views of first and second variations;

FIGS. 7A and 7B are a view and a table of a third variation;

FIG. 8 is a view of one example of a flow path configuration in the case of providing an infinitesimal flow rate pump allowing suction operation; and

FIG. 9 is a view of a second embodiment.

### DETAILED DESCRIPTION OF THE EXEMPLARY EMBODIMENTS

Hereinafter, embodiments of the present invention will be described with reference to the drawings.

### First Embodiment

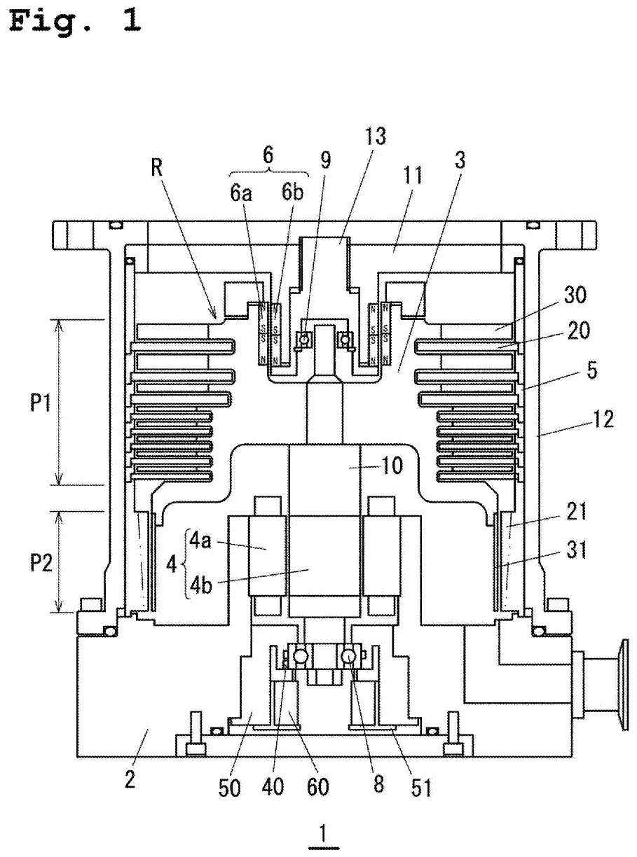

FIG. 1 is a view of a first embodiment of a vacuum pump according to the present invention, and illustrates a section of a turbo-molecular pump 1. The turbo-molecular pump 1 includes a power device configured to supply power to a pump main body, but such a power device is not shown in FIG. 1.

The turbo-molecular pump 1 includes, as exhaust functions, a turbo pump section P1 having turbine blades, and a Holweck pump section P2 having a spiral groove. Needless to say, the present invention is not limited to the vacuum pump including the turbo pump section P1 and the Holweck pump section P2 as the exhaust functions, and is also applicable to a vacuum pump including only turbine blades, a vacuum pump including only a drag pump such as a Siegbahn pump or a Holweck pump, or a combination thereof.

The turbo pump section P1 includes multiple stages of rotor blades 30 formed at a pump rotor 3, and multiple stages of stationary blades 20 arranged on abase 2 side. On the other hand, the Holweck pump section P2 provided on an exhaust downstream side of the turbo pump section P1 includes a cylindrical portion 31 formed at the pump rotor 3, and a stator 21 arranged on the base 2 side. The spiral groove is formed at an inner peripheral surface of the cylindrical stator 21. The multiple stages of the rotor blades 30 and the cylindrical portion 31 forma rotary-side exhaust function, and the multiple stages of the stationary blades 20 and the stator 21 form a stationary-side exhaust function.

The pump rotor 3 is fastened to a shaft 10, and the shaft 10 is rotatably driven by a motor 4. For example, a DC brushless motor is used as the motor 4. A motor stator 4a is provided at abase 2, and a motor rotor 4b is provided on a shaft 10 side. A rotor unit R including the shaft 10 and the pump rotor 3 is rotatably supported by a permanent magnet magnetic bearing 6 using permanent magnets 6a, 6b and a bearing 8 as a rolling bearing.

The permanent magnets 6a, 6b are ring-shaped permanent magnets magnetized in an axial direction. The multiple permanent magnets 6a provided at the pump rotor 3 are arranged in the axial direction such that those with the same polarity face each other. On the other hand, the multiple stationary-side permanent magnets 6b are attached to a magnet holder 11 fixed to a pump case 12. These multiple permanent magnets 6b are also arranged in the axial direction such that those with the same polarity face each other.

The axial position of the permanent magnet 6a provided at the pump rotor 3 is set slightly higher than the position of the permanent magnet 6b arranged on an inner peripheral side of the permanent magnet 6a. That is, the magnetic pole of the rotary-side permanent magnet is, by a predetermined amount, shifted in the axial direction with respect to the magnetic pole of the stationary-side permanent magnet. Depending on the magnitude of the predetermined amount, support force of the permanent magnet magnetic bearing 6 varies. In an example illustrated in FIG. 1, the permanent magnets 6a are arranged on an upper side as viewed in the figure, and therefore, support force in a radial direction and upward (a direction toward a pump exhaust port) force in the axial direction act on the rotor unit R due to repulsive force of the permanent magnets 6a and the permanent magnets 6b.

A bearing holder 13 configured to hold a bearing 9 is fixed to the center of the magnet holder 11. In FIG. 1, deep groove ball bearings are used as the bearings 8, 9, but the present invention is not limited to above. For example, angular contact bearings may be used. The bearing 9 functions as a touchdown bearing configured to limit radial runout of a shaft upper portion. In a steady rotation state, the shaft 10 and the bearing 9 do not contact each other. In a case where great disturbance is applied or whirling of the shaft 10 becomes greater upon acceleration or deceleration of rotation, the shaft 10 contacts the bearing 9.

The bearing 8 is held by a bearing holder 50 provided at the base 2. A lubrication fluid storage section 60 configured to store lubrication fluid to be supplied to the bearing 8 is provided at the bearing holder 50. Liquid lubricant such as lubricant oil is used as the lubrication fluid for the bearing 8.

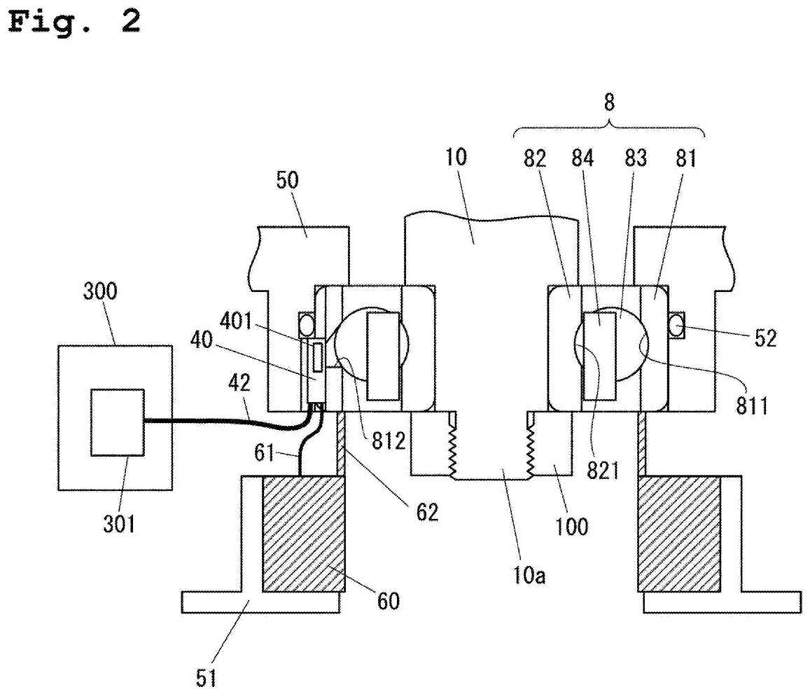

FIG. 2 is a view for describing a lubrication system for the bearing 8 by means of the lubrication fluid, and illustrates a portion of the bearing holder 50 in detail. The bearing 8 includes an outer ring 81, an inner ring 82, a rolling body 83, and a holder 84. The inner ring 82 is fixed to the shaft 10 with a nut 100, and the outer ring 81 is held at the bearing holder 50. A radial damper 52 arranged on an outer peripheral side of the outer ring 81 is provided between the outer ring 81 and the bearing holder 50. For example, an elastic member of rubber is used as the radial damper 52.

The lubrication fluid storage section 60 is provided at a storage holder 51 fixed to a lower end (see FIG. 1) of the bearing holder 50. The ring-shaped lubrication fluid storage section 60 is made of a felt-like or sponge-like porous material, porous sintered plastic, or porous sintered metal, and the lubrication fluid is stored in many microvoids formed at the porous material. When the lubrication fluid contacts the porous material with many microvoids, the lubrication fluid penetrates the porous material and expands to a surrounding region due to capillary force. Such capillary force depends on microvoid spatial dimensions and wettability of an inner surface in a space as described later. A structure having sufficient capillary force for expanding the lubrication fluid across a flow path of the lubrication system will be referred to as a “capillary structure” in the present embodiment. Moreover, the felt-like or sponge-like porous material, the porous sintered plastic, the porous sintered metal and the like ensuring proper wettability will be referred to as a “capillary material.”

Rolling surfaces 811, 821 are formed at an inner peripheral surface of the outer ring 81 and an outer peripheral surface of the inner ring 82. A micro electro mechanical systems (MEMS) element 40 incorporating an infinitesimal flow rate pump 401 is, by bonding or the like, fixed to an outer peripheral surface of the outer ring 81. Note that the MEMS is a device system configured such that a minute mechanical component, a sensor, an actuator and the like and an electronic circuit are integrated on a single substrate (e.g., a silicon substrate, a glass substrate, or an organic material). In the present embodiment, the lubrication fluid is supplied to the bearing 8 by the infinitesimal flow rate pump 401 incorporated into the MEMS element 40. The lubrication fluid flows into the inner peripheral side rolling surface 811 through a through-hole 812 formed at the outer ring 81, and a lubrication fluid film is formed on surfaces of the rolling body 83 and the rolling surfaces 811, 821.

The MEMS element 40 is drivably controlled by a drive circuit 301 connected through a cable 42. In the present embodiment, the drive circuit 301 is provided at a power device 300 of the turbo-molecular pump, but may be provided on a pump main body side. The MEMS element 40 and the lubrication fluid storage section 60 are connected to each other through a suction tube 61 configured to guide the lubrication fluid of the lubrication fluid storage section 60 to the MEMS element 40 by the capillary force. Moreover, a lubrication fluid return section 62 made of the capillary material is provided between a lower end of the outer ring 81 and an upper end of the lubrication fluid storage section 60 in contact with both of the outer ring 81 and the lubrication fluid storage section 60. Moreover, the suction tube 61 is also made of the capillary material, and for example, a tube filled with the porous material such as felt is used. The lubrication fluid discharged from the rolling surface 811 of the outer ring 81 returns to the lubrication fluid storage section 60 through the lubrication fluid return section 62.

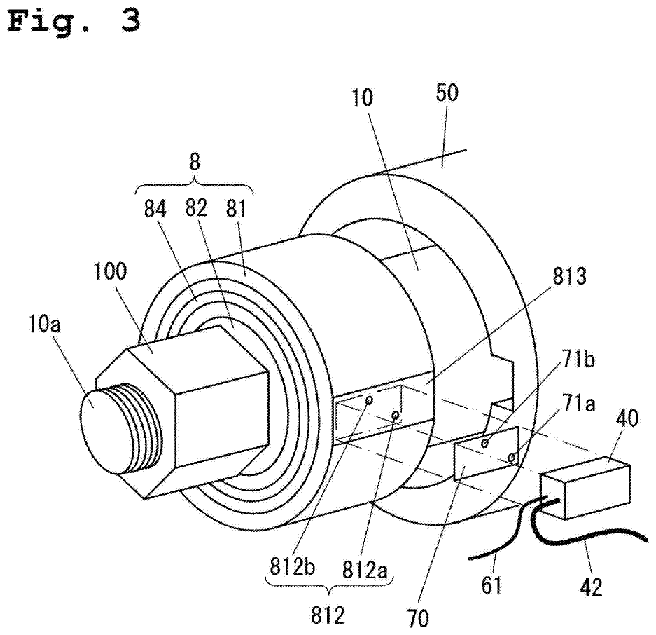

FIG. 3 is a perspective view of the bearing 8 provided at the shaft 10. The nut 100 is screwed onto an external thread portion 10a formed at a lower end of the shaft 10, and in this manner, the inner ring 82 of the bearing 8 is fixed to the shaft 10. A planar portion 813 is formed at the outer peripheral surface of the outer ring 81, and the above-described through-hole 812 (812a, 812b) penetrates from the planar portion 813 formed at the outer ring 81 to the inner peripheral side and communicates with a portion in close proximity of the rolling surface 811.

The MEMS element 40 incorporating the infinitesimal flow rate pump 401 is bonded and fixed to the planar portion 813 of the outer ring 81. A packing 70 made of, e.g., a thin plate material of rubber is arranged as a seal material between the MEMS element 40 and the outer ring 81. Through-holes 71a, 71b are formed at locations of the packing 70 facing the through-holes 812a, 812b of the outer ring 81. The through-holes 812a, 812b function as flow paths for supplying the lubrication fluid. The lubrication fluid supplied from the infinitesimal flow rate pump 401 of the MEMS element 40 flows into the inner peripheral side of the outer ring 81 through the through-hole 812 (812a, 812b), and adheres to the rolling body 83 upon passage of the rolling body 83 (see FIG. 2). The lubrication fluid expands across the rolling surfaces 811, 821 by contact between each rolling surface 811, 821 and the rolling body 83, and is provided for lubrication of this portion.

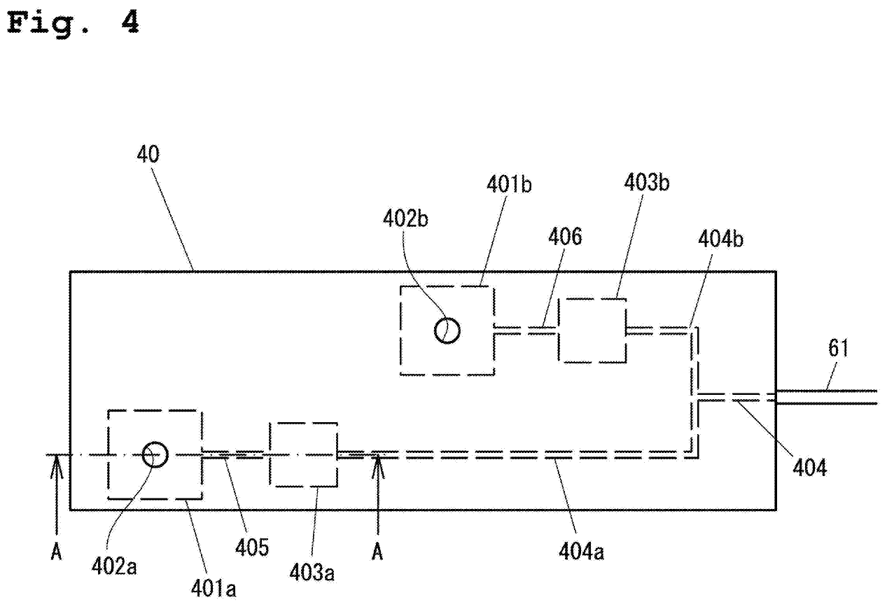

FIG. 4 is a view of the MEMS element 40, the MEMS element 40 being viewed from a planar portion 813 side of the outer ring 81 as an attachment surface. As described above, the MEMS element 40 incorporates the infinitesimal flow rate pump 401 (401a, 401b). The lubrication fluid sent out of a nozzle 402a of the infinitesimal flow rate pump 401a flows into the inner peripheral side of the outer ring 81 through the through-hole 812a illustrated in FIG. 3. Meanwhile, the lubrication fluid sent out of a nozzle 402b of the infinitesimal flow rate pump 401b flows into the inner peripheral side of the outer ring 81 through the through-hole 812b illustrated in FIG. 3.

The suction tube 61 configured to guide the lubrication fluid from the lubrication fluid storage section 60 to the MEMS element 40 is connected to a flow path 404 formed at the MEMS element 40. The flow path 404 is, in the middle thereof, branched into flow paths 404a, 404b. A valve 403a is provided between the flow path 404a and a flow path 405 communicating with the infinitesimal flow rate pump 401a. A valve 403b is provided between the flow path 404a and a flow path 406 communicating with the infinitesimal flow rate pump 401b.

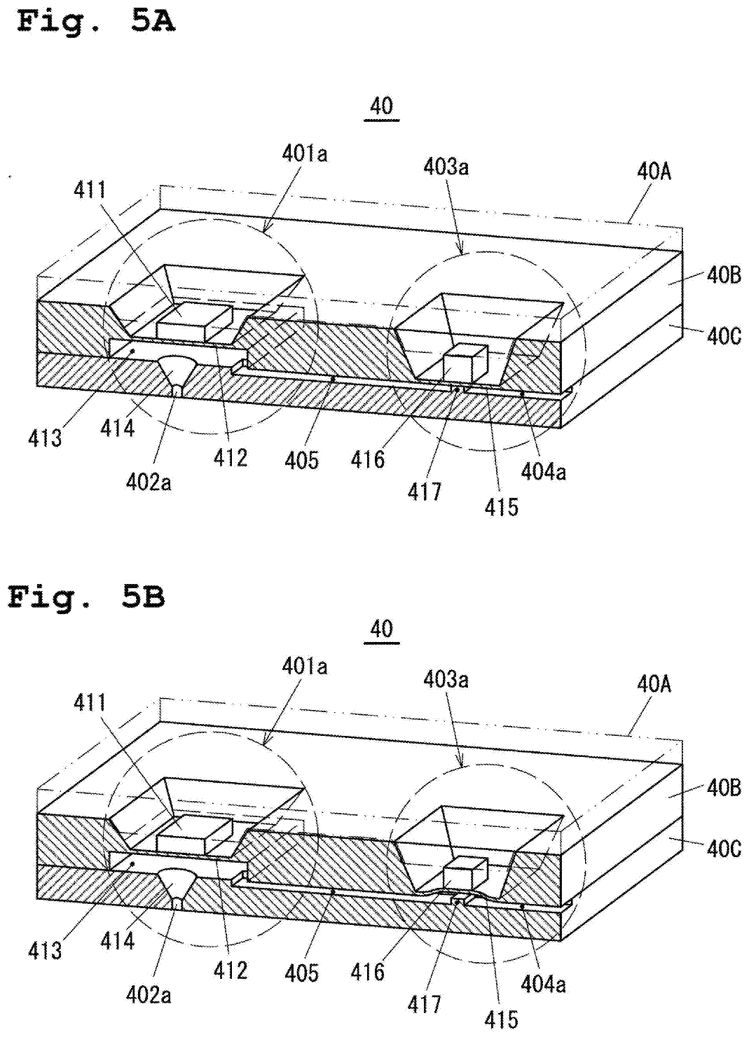

FIGS. 5A and 5B are views of an A-A section of FIG. 4. FIG. 5A illustrates a case where the valve 403a is in a closed state, and FIG. 5B illustrates a case where the valve 403b is in an open state. The infinitesimal flow rate pump 401a of the present embodiment illustrated in FIGS. 5A and 5B is a pump having such a structure that the lubrication fluid is transferred using a piezoelectric element. The type of infinitesimal flow rate pump using the piezoelectric element is a pump employing a method in which pressure is applied to an inflow fluid capacity (a pressure chamber) by a combination of a deflectable thin plate or a deflectable thin plate forming portion and the piezoelectric element to send out the fluid.

As illustrated in FIGS. 5A and 5B, the MEMS element 40 has such a structure that three layers of an upper layer 40A, an intermediate layer 40B, and a lower layer 40C are bonded to each other. Note that the upper layer 40A is indicated by a chain double-dashed line. The infinitesimal flow rate pump 401a includes a piezoelectric element 411, a diaphragm 412, and a pressure chamber 413. Voltage application to the piezoelectric element 411 is controlled by the drive circuit 301. An upper surface of the piezoelectric element 411 is fixed to the upper layer 40A, and a lower surface of the piezoelectric element 411 is fixed to the diaphragm 412. An opening 414 as an inlet of the nozzle 402a is formed at a location facing the diaphragm 412 at the pressure chamber 413. The opening 414 is formed in a conical shape expanding as extending toward a pressure chamber 413 side.

The valve 403a includes a valve body 415 having a diaphragm, a piezoelectric element 416 configured to drive the valve body 415, and a valve seat 417 provided at a location facing the valve body 415. Voltage application to the piezoelectric element 416 is controlled by the drive circuit 301. An upper surface of the piezoelectric element 416 is fixed to the upper layer 40A, and a lower surface of the piezoelectric element 416 is fixed to the valve body 415. In the state illustrated in FIG. 5A, the valve body 415 and the valve seat 417 are in close contact with each other, and the valve 403a is in the closed state. As a result, the flow path 404a and the flow path 405 are blocked from each other.

In the valve closed state illustrated in FIG. 5A, when voltage is applied to the piezoelectric element 411 of the infinitesimal flow rate pump 401a, the lubrication fluid in the pressure chamber 413 is sent out of the nozzle 402a. That is, when voltage is applied to the piezoelectric element 411, the piezoelectric element 411 is extended in an upper-to-lower direction as viewed in the figure, and the diaphragm 412 is pushed down as viewed in the figure to pressurize the pressure chamber 413. By such pressurization, part of the lubrication fluid in the pressure chamber 413 flows out of the nozzle 402a through the opening 414.

When the lubrication fluid is supplied to the pressure chamber 413 of the infinitesimal flow rate pump 401a, voltage is applied to the piezoelectric element 416 of the valve 403a to bring the valve 403a into the open state as illustrated in FIG. 5B. When voltage is applied to the piezoelectric element 416, the piezoelectric element 416 is contracted in the upper-to-lower direction as illustrated in FIG. 5B to lift the valve body 415 upward. Accordingly, a clearance is formed between the valve body 415 and the valve seat 417, and therefore, the valve 403a is brought into the open state. As a result, the flow path 404a and the flow path 405 communicate with each other.

Note that a lubrication fluid circulation system including the bearing 8 and the lubrication fluid storage section 60 is in vacuum environment, and therefore, an atmospheric pressure difference cannot be utilized for movement of the lubrication fluid. For this reason, in the present embodiment, it is configured such that the capillary force in capillary action is utilized to move the lubrication fluid in the flow path 404a to the pressure chamber 413. That is, the dimensions of the flow paths 404a, 405 and the pressure chamber 413 are set to such dimensions that proper capillary force is generated. Details of the capillary force will be described later.

Note that the type of infinitesimal flow rate pump 401a using the piezoelectric element has been described as an example with reference to FIGS. 5A and 5B, but the structure of the infinitesimal flow rate pump 401a is not limited to above. Other types of infinitesimal flow rate pumps may be applied. For example, one employing a method in which part of a sealed fluid capacity is rapidly heated to vaporization to generate bubbles and a volume is accordingly increased to push out the fluid (a liquefied portion) and one employing a method in which potential is provided to a surface facing a charged thin plate (diaphragm) to displace the thin plate by repulsive force or attraction force due to static electricity and fluid is accordingly sucked or pushed out have been known as the infinitesimal flow rate pump incorporated into the MEMS element 40.

For the bearing 8 supporting the shaft 10 rotating at high speed, a lubrication state is the best, in which an agitation loss of the lubrication fluid is reduced as much as possible for reducing heat generation and contact between solids due to the broken lubrication fluid film is avoided upon rolling of the rolling body 83. Thus, an ideal thickness of the lubrication fluid film present on the rolling surfaces 811, 821 of the bearing 8 and the surface of the rolling body 83 of the bearing 8 is about several times as great as the surface roughness of these surfaces. For example, in a case where the rolling surfaces 811, 821 and the surface of the rolling body 83 are finished with a root-mean-square roughness R_{q} of 0.04 μm, the thickness of the lubrication fluid film is preferably about 0.12 to 0.20 μm.

As described above, the lubrication fluid having entered the bearing 8 is decreased little by little due to, e.g., outflow from an end portion of the outer ring 81, and for compensating for such a decrement, the lubrication fluid is supplied by the infinitesimal flow rate pumps 401a, 401b. In a case where an oil film having a thickness of equal to or less than 1 μm is formed at each spot in the bearing 8, the amount of lubrication fluid present in the bearing 8 is about several mg (equivalent to several μL (microliters) in terms of a volume). An outflow amount per second varies according to the structure of a portion from which the lubrication fluid flows out, but for example, is about 1/100 to 1/10000 of the amount of lubrication fluid accumulated in the bearing 8. Thus, this amount of lubrication fluid (a slight amount of several nL (nanoliters) per second or less) is supplied so that the thickness of the lubrication fluid film can be favorably maintained. In the present embodiment, for supplying a slight amount of lubrication fluid such as several nL (nanoliters) per second or less to the bearing 8, the infinitesimal flow rate pumps 401a, 401b incorporated into the MEMS element 40 are used.

(Lubrication Fluid Circulation System)

In the lubrication fluid circulation system illustrated in FIG. 2, the lubrication fluid of the lubrication fluid storage section 60 circulates in the order of the lubrication fluid storage section 60, the suction tube 61, the MEMS element 40, the bearing 8, the lubrication fluid return section 62, and the lubrication fluid storage section 60. Of this circulation path, at least a flow path from the lubrication fluid storage section 60 to the infinitesimal flow rate pumps 401a, 401b of the MEMS element 40 utilizes the capillary force for movement of the lubrication fluid. In the lubrication fluid return section 62, the force of gravity can be utilized to return the lubrication fluid to the lubrication fluid storage section 60. However, the lubrication fluid return section 62 is made of the capillary material to utilize the capillary force, and therefore, the lubrication fluid can be returned to the lubrication fluid storage section 60 regardless of a pump posture.

Pressure calculated according to Expression (1) below acts on a vacuum interface of the lubrication fluid in a capillary tube with an inner diameter d. Note that T indicates a tension (N/m) on the vacuum interface of the lubrication fluid, and θ indicates a contact angle representing wettability of a contact surface for the lubrication fluid. In this case, when the capillary tube stands along the direction of the force of gravity, the interface moves upward to a height h of (4 T cos θ)/ρgd. Note that ρ indicates a liquid density and g indicates a gravitational acceleration. That is, in the capillary material such as a thin tube or felt, the lubrication fluid moves (penetrates) and expands across the capillary material due to the capillary force.

(4T cos θ)/d (1)

For example, in a case where a member having a contact angle θ of 15° is used as a material with favorable wettability and a flow path has an inner diameter d of 1.0×10⁻⁵ m=10 μm and a case where lubrication fluid having a surface tension T of 2.6×10⁻² N/m is used, the capillary force of Expression (1) is a pressure of about 10 kPa. When the density of the lubrication fluid is ρ=1000 kg/m³ and the gravitational acceleration is g=9.8 m/s², the height h of the interface of the lubrication fluid in the capillary tube under the force of gravity is about 100 cm.

In the case of using the capillary material for the lubrication fluid storage section 60 and the lubrication fluid return section 62 in the lubrication fluid circulation system illustrated in FIG. 2, a void diameter dimension (in the case of the porous material) and a fiber clearance (in the case of the felt or the like) correspond to the above-described inner diameter d of the capillary tube. In the present embodiment, these dimensions are set to equal to or less than such values that proper capillary force is generated. Moreover, the dimensions of the flow paths 404 to 406 and the pressure chamber 413 formed at the MEMS element 40 are also set to equal to or less than values corresponding to the inner diameter d. The MEMS element 40 has a fine structure, and therefore, these conditions are fully satisfied in this case. Further, for the suction tube 61, the inner diameter of the suction tube 61 may be set to the above-described inner diameter d, or a capillary material, such as felt, filling a thick tube may be used. As described above, the clearance dimensions in the path for circulating the lubrication fluid are set to such dimensions that sufficient capillary force is generated, and therefore, the lubrication fluid can be properly supplied by the infinitesimal flow rate pumps 401a, 401b.

The amount of lubrication fluid to be supplied to the bearing 8 by the infinitesimal flow rate pumps 401a, 401b is about several nL (nanoliters) per second as described above. In an infinitesimal flow rate pump used for, e.g., an inkjet head of a printer as described in Japanese Patent No. 3171958, a picoliter-order slight amount can be discharged per pulse. For example, in a case where the infinitesimal flow rate pumps 401a, 401b are pumps configured so that 10 picoliters can be transferred per pulse, if the lubrication fluid is transferred with 100 pulses per second, a supply amount is 2 nanoliters. That is, the infinitesimal flow rate pumps 401a, 401b incorporated into the MEMS element 40 are used so that a nanoliter-order slight amount of lubrication fluid per second can be supplied to the bearing 8. Note that the supply amount (the transfer amount) of the lubrication fluid by the infinitesimal flow rate pumps 401a, 401b can be adjusted in such a manner that the frequency of stretching vibration of the piezoelectric element 411 is controlled by the drive circuit 301.

Note that as clearly seen from Expression (1), not only the dimensions of the capillary tube and the surface tension of the fluid interface but also the wettability of the surface contacting the fluid are important factor for determining the capillary force. Generally, as clearly seen from the fact that degreasing processing needs to be performed for a wafer material, such as monocrystal silicon, used for the MEMS element 40 before chemical processing fora surface, the wafer material basically exhibits lipophilicity (favorable wettability). However, in a case where an oleophobic (liquid-repellent) substance as a coating adheres to the surface in the middle of a processing step, the wettability is extremely degraded. For this reason, at the processing step for the MEMS element 40, the step of avoiding the oleophobic substance from adhering to an inner surface of the flow path is employed so that favorable wettability can be realized.

(First Variation)

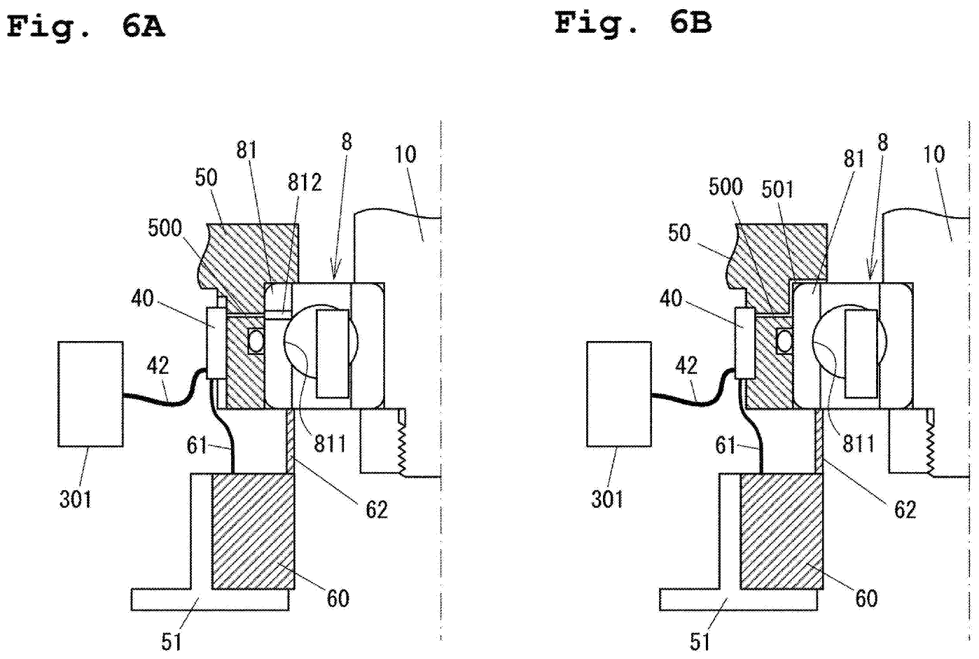

FIG. 6A is a view of a first variation of the present embodiment. In the above-described embodiment, the MEMS element 40 equipped with the infinitesimal flow rate pumps 401a, 401b are fixed to the outer peripheral surface of the outer ring 81. However, in the first variation, the MEMS element 40 is fixed to the outer peripheral side of the bearing holder 50. A though-hole 500 is formed at a location facing the nozzle 402a (not shown) of the infinitesimal flow rate pump 401a (not shown) at the bearing holder 50. Further, the through-hole 812 communicating with the though-hole 500 is formed at the outer ring 81 of the bearing 8. The lubrication fluid sent out of the infinitesimal flow rate pump 401a to the though-hole 500 is supplied to the inner peripheral side of the outer ring 81 through the though-hole 500 and the through-hole 812, and reaches the rolling surface 811. Note that a through-hole for the infinitesimal flow rate pump 401b is not shown in the figure.

Note that the lubrication fluid sent out of the infinitesimal flow rate pump 401a is moved to an outer ring 81 side in the though-hole 500 by pressing force upon driving of the piezoelectric element 411 (see FIGS. 5A and 5B). The dimensions of the though-hole 500 are set to such dimensions that proper capillary force is generated, and therefore, the capillary force can be utilized for movement of the lubrication fluid.

(Second Variation)

FIG. 6B is a view of a second variation of the present embodiment. In the second variation, a groove 501 forming a flow path of the lubrication fluid is formed on the inner peripheral side of the bearing holder 50 instead of forming the through-hole 812 at the outer ring 81. One end of the groove 501 communicates with the though-hole 500, and the other end of the though-hole 500 communicates with the inner peripheral side of the outer ring 81. The diameter dimension of the groove 501 is set such that the lubrication fluid is moved to the inner peripheral surface of the outer ring 81 from the though-hole 500 by the capillary force. In the case of the second variation, the flow path (the groove 501) of the lubrication fluid is formed at the bearing holder 50. Thus, as compared to the configuration of FIG. 6A in which the through-hole 812 is formed at the outer ring 81 of the bearing 8, the flow path can be more easily formed.

(Third Variation)

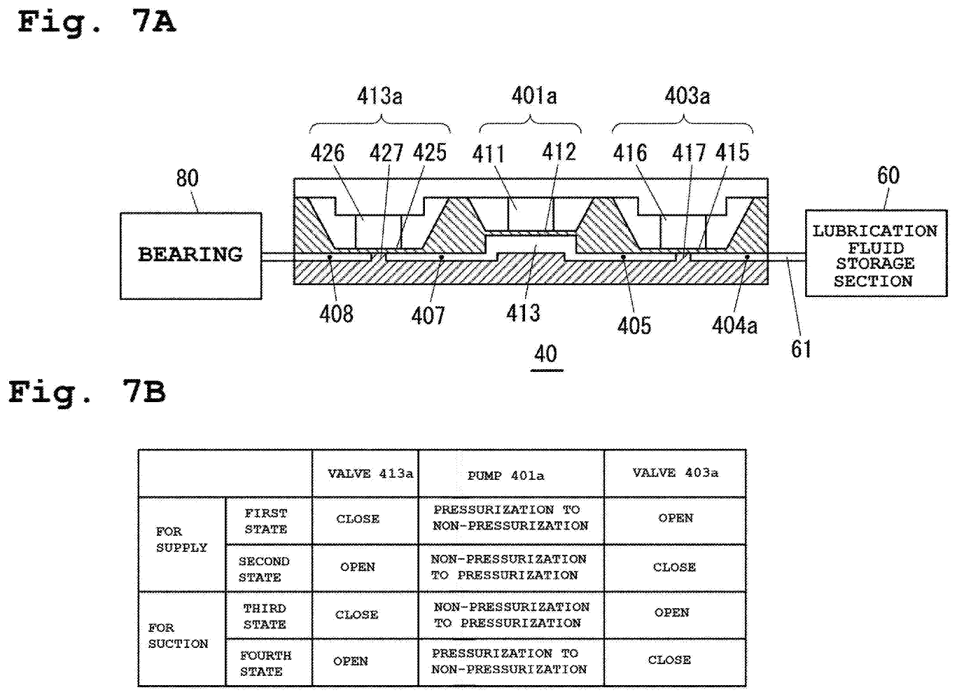

FIGS. 7A and 7B are a view and a table of a third variation of the present embodiment. In the MEMS element 40 illustrated in FIG. 4, the infinitesimal flow rate pumps 401a, 401b have only the function of supplying the lubrication fluid to the bearing 8. However, the third variation has such a configuration that the function of sucking excessive lubrication fluid is provided in addition to the function of supplying the lubrication fluid.

FIG. 7A is a schematic view of the infinitesimal flow rate pump 401a and the valves connected thereto, and the pair of valves 403a, 413a is provided for the infinitesimal flow rate pump 401a. Note that although not shown in the figure, a single valve is also similarly provided as the valve 403b. As in the case of FIG. 4, the valve 403a is provided between the flow path 404a and the flow path 405 communicating with the pressure chamber 413 of the infinitesimal flow rate pump 401a. When voltage is applied to the piezoelectric element 416, the clearance is formed between the valve body 415 and the valve seat 417, and accordingly, the valve 403a is brought into the open state. Thus, the flow path 405 and the flow path 404a communicate with each other.

On the other hand, the valve 413a is provided between a flow path 408 and a flow path 407 communicating with the pressure chamber 413 of the infinitesimal flow rate pump 401a. The flow path 408 communicates with the through-hole 812 (see FIG. 2) formed at the outer ring 81 of the bearing 8. The valve 413a includes a valve body 425, a piezoelectric element 426, and a valve seat 427. When voltage is applied to the piezoelectric element 426, the piezoelectric element 426 is contracted in the upper-to-lower direction as viewed in the figure to lift the valve body 425, and accordingly, a clearance is formed between the valve body 425 and the valve seat 427. That is, the valve 413a is brought into an open state, and therefore, the flow path 407 and the flow path 408 communicate with each other.

In the MEMS element 40 configured as illustrated in FIG. 7A, the infinitesimal flow rate pump 401a and the valves 403a, 413a are operated as in an operation table illustrated in FIG. 7B, and therefore, supply of the lubrication fluid to the bearing 8 and suction of the lubrication fluid (excessive lubrication fluid) from the bearing 8 can be performed.

First, operation upon supply will be described. Upon supply, operation of a first state and operation of a second state are alternately repeated. In the first state, the valve 403a is brought into the open state, and the valve 413a is brought into a closed state. Voltage application to the piezoelectric element 411 of the infinitesimal flow rate pump 401a is stopped. That is, the pressure chamber 413 changes from a pressurization state to a non-pressurization state. In the second state, the valve 403a is brought into the closed state, and the valve 413a on a bearing side is brought into the open state. Further, by voltage application to the piezoelectric element 411, the pressure chamber 413 changes from the non-pressurization state to the pressurization state. As a result, the lubrication fluid is sent out to the bearing 8.

Next, operation upon suction will be described. Upon suction, operation of a third state and operation of a fourth state are alternately repeated. In the third state, the valve 403a is brought into the open state, and the valve 413a is brought into the closed state. Further, by voltage application to the piezoelectric element 411, the pressure chamber 413 changes from the non-pressurization state to the pressurization state. As a result, the lubrication fluid in the pressure chamber 413 is sent out to a flow path 404a side through the flow path 405. In the fourth state, the valve 403a is brought into the closed state, and the valve 413a on the bearing side is brought into the open state. Moreover, voltage application to the piezoelectric element 411 is stopped. The pressure chamber 413 is brought into the non-pressurization state with a greater capacity from the pressurization state, and the lubrication fluid on a flow path 408 side moves toward the flow path 407 through the clearance formed between the valve body 425 and the valve seat 427. As a result, the lubrication fluid on a bearing 8 side is sucked. Note that the method for making a diagnosis on whether or not the lubrication fluid is excessive will be described in detail in a later-described second embodiment.

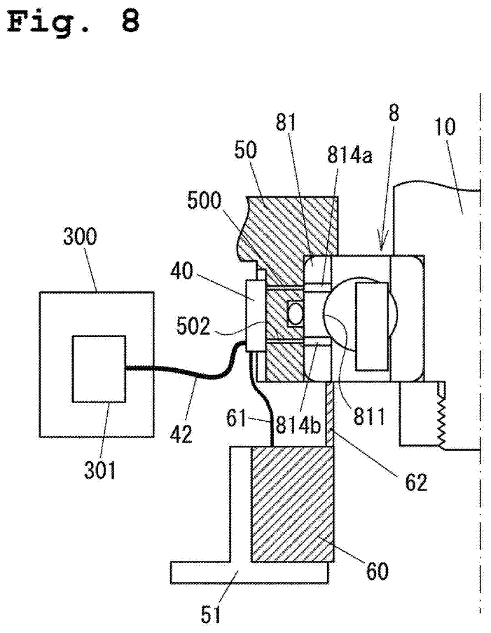

In the case of the MEMS element 40 including the infinitesimal flow rate pump allowing suction operation, a flow path configuration illustrated in FIG. 8 may be employed, for example. In the configuration illustrated in FIG. 8, a through-hole 814a is formed in the vicinity of the upper side of the rolling surface 811 of the outer ring 81 as viewed in the figure, a through-hole 814b is formed in the vicinity of a lower side of the rolling surface 811 as viewed in the figure, and the though-holes 500, 502 each communicating with the through-holes 814a, 814b are formed at the bearing holder 50. In this case, it may be configured so that the lubrication fluid can be supplied and sucked through any of the though-holes 500, 502, or it may be configured such that the though-hole 500 is provided only for supply and the through-hole 502 is provided for supply and suction. In the case of using the though-hole 500 only for supply, the infinitesimal flow rate pump 401a and the valve 403a illustrated in FIG. 4 may be arranged at the through-hole 814a.

As described above, in the present embodiment, the infinitesimal flow rate pumps 401a, 401b formed at the MEMS element 40 are used as sections configured to transfer the lubrication fluid of the lubrication fluid storage section 60 to the bearing 8, the suction tube 61 as the flow path of the capillary structure is provided as a section configured to move the lubrication fluid from the lubrication fluid storage section 60 to the infinitesimal flow rate pumps 401a, 401b, and the lubrication fluid is moved using the capillary force. As a result, supply of a slight amount of lubrication fluid to the bearing in the vacuum environment can be stably performed.

Regarding arrangement of the MEMS element 40, the MEMS element 40 may be fixed to the outer peripheral surface of the outer ring 81 of the bearing 8 as in FIGS. 2 and 3, or may be fixed to the outer peripheral side of the bearing holder 50 functioning as a holding section for the bearing 8 as illustrated in FIGS. 6A and 6B.

In the configuration in which the MEMS element 40 is fixed to the outer peripheral surface of the outer ring 81 as in FIGS. 2 and 3, the lubrication fluid sent out of the infinitesimal flow rate pump 401 (401a, 401b) is guided to the inner peripheral side of the outer ring 81 through the through-hole 812 (812a, 812b) formed at the outer ring 81. Note that instead of forming the through-hole 812 at the outer ring 81 in the configuration of FIGS. 2 and 3, the groove illustrated in FIG. 6B may be formed at an outer ring outer peripheral surface and outer ring upper end surface of the bearing 8 such that the lubrication fluid sent out of the infinitesimal flow rate pumps 401a, 401b is moved to the inner peripheral side of the outer ring 81 by means of the capillary force.

In the configuration in which the MEMS element 40 is fixed to the outer peripheral side of the bearing holder 50, the lubrication fluid may be guided to the inner peripheral side of the outer ring 81 through the though-hole 500 of the bearing holder 50 and the through-hole 812 of the outer ring 81 as illustrated in FIG. 6A, or may be guided to the inner peripheral side of the outer ring 81 through the though-hole 500 and the groove 501 formed at the bearing holder 50 as illustrated in FIG. 6B. The lubrication fluid sent out of the infinitesimal flow rate pumps 401a, 401b is basically transferred to the inner peripheral side of the outer ring 81 by the pressing force of the piezoelectric element 411. However, the capillary structure may be employed for the though-hole 500 and the groove 501 to utilize the capillary force for movement of the lubrication fluid.

### Second Embodiment

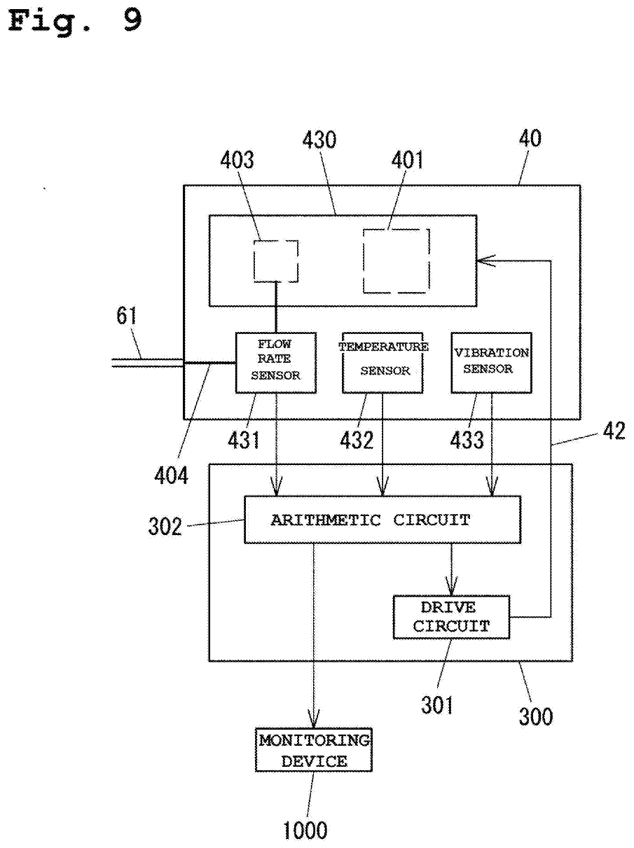

FIG. 9 is a view of a second embodiment. In the above-described first embodiment, the MEMS element 40 includes, as illustrated in FIG. 4, the infinitesimal flow rate pumps 401a, 401b and the valves 403a, 403b as the lubrication fluid circulation system, for example. On the other hand, in the second embodiment, a MEMS element 40 includes, in addition to a lubrication fluid circulation system 430 having an infinitesimal flow rate pump 401 and a valve 403, a flow rate sensor 431, a temperature sensor 432, and a vibration sensor 433 such as an acceleration sensor.

The lubrication fluid circulation system 430 may have the configuration illustrated in FIG. 4, or may have a configuration in which both of supply operation and suction operation as illustrated in FIGS. 7A and 7B are performed. That is, in the case of the configuration of FIG. 4, the infinitesimal flow rate pump 401 corresponds to the infinitesimal flow rate pumps 401a, 401b, and the valve 403 corresponds to the valves 403a, 403b. In the case of the configuration of FIGS. 7A and 7B, the infinitesimal flow rate pump 401 corresponds to the infinitesimal flow rate pump 401a, and the valve 403 corresponds to the valves 403a, 413a.

The flow rate sensor 431 is configured to measure the flow rate of lubrication fluid flowing in a flow path 404, i.e., the flow rate of lubrication fluid flowing from a suction tube 61 to the infinitesimal flow rate pump 401. The temperature sensor 432 is configured to measure the temperature of an outer ring 81 of a bearing 8 to which the MEMS element 40 is fixed. The vibration sensor 433 is configured to measure vibration generated at the outer ring 81. Note that in the case of detecting the temperature and vibration of the outer ring 81, the MEMS element 40 is preferably directly fixed to the outer ring 81 as illustrated in FIG. 2, but may be fixed to a bearing holder 50 as illustrated in FIGS. 6A and 6B.

As described above, the configuration in which the MEMS element is equipped with the flow rate sensor, the temperature sensor, the vibration sensor and the like is well-known. For example, one employing a method in which a change in a capacitance due to a change in a specific clearance state in association with an acceleration or vibration is detected as disclosed in JP-A-5-25687 and Japanese Patent No. 4804468 can be utilized as the vibration sensor 433. For example, one employing a method in which movement of heat generated due to movement of fluid is measured as disclosed in JP-A-6-066613 can be utilized as the flow rate sensor 431. For example, one using a thermocouple or a platinum resistance temperature detector can be utilized as the temperature sensor 432.

A power device 300 includes a drive circuit 301 configured to drivably control the infinitesimal flow rate pump 401 and the valve 403, and an arithmetic circuit 302 to which measurement signals from the flow rate sensor 431, the temperature sensor 432, and the vibration sensor 433 are input. The arithmetic circuit 302 is configured to make a diagnosis regarding the lubrication fluid for the bearing 8 based on the input measurement signals.

In the arithmetic circuit 302, the state of lubrication in the bearing 8 is estimated from a change in the temperature of the outer ring 81 and characteristics of vibration generated at the outer ring 81. As illustrated in FIG. 2, the bearing 8 is a ball bearing using a spherical body as a rolling body 83. Contact between a ball of the ball bearing and a rolling surface of each of inner and outer rings is partially “slipping” contact. In general terms, metal contact in which an oil film is present between contact surfaces shows multiple forms represented by a so-called Stribeck curve in the order of a boundary lubrication region, a mixed lubrication region, and a fluid lubrication region according to a ratio between the thickness of the present oil film and a surface roughness representative value of a metal surface.

It is demanded for the bearing 8 of the turbo-molecular pump illustrated in FIG. 1 that operation is performed with a state closest possible to the mixed lubrication region in the fluid lubrication region being maintained. In this region, a friction coefficient is the minimum, and a rotation loss of the bearing can be suppressed low. On the other hand, in the mixed lubrication region, there is a probability that metal contact is caused due to a broken lubricant oil film and, e.g., a sudden increase in the loss or galling is caused. Moreover, as the lubricant oil film is thickened, agitation resistance of lubricant oil is increased, and therefore, the rotation loss is increased.

For these reasons, in the arithmetic circuit 302, an increase or decrease in the thickness of the lubricant oil film on the rolling surface is estimated from the characteristics of vibration caused due to rolling of the rolling body. For example, in a case where the lubricant oil film thickness is a proper state (a normal state), when vibration data of the vibration sensor 433 is processed by FFT, peaks are shown at a vibration frequency corresponding to a rotor rotation frequency and multiples thereof and a vibration frequency corresponding to a component (the outer ring 81, an inner ring 82, the rolling body 83, and a holder 84) of the bearing 8. However, when the lubricant oil film thickness decreases to reach the mixed lubrication region, sudden vibration such as impact noise caused due to contact between protruding portions of metal surfaces is observed at a point different from the above-described vibration frequencies of the peaks, and the peak value of the vibration frequency corresponding to the component of the bearing 8 increases. Thus, it can be estimated that the amount of lubrication fluid becomes less than a proper amount due to occurrence of the sudden vibration.

In a case where the temperature sensor 432 is also equipped as in FIG. 9, a sharp temperature increase due to contact between the protruding portions of the metal surfaces upon a lubrication fluid decrease is also often observed. Thus, in a case where occurrence of the sudden vibration and the temperature increase have been observed or either one of occurrence of the sudden vibration or the sharp temperature increase has been observed, it can be estimated that the lubrication fluid amount has decreased.

On the other hand, an agitation phenomenon becomes notable when the lubricant oil film is thickened, and a phenomenon in which an amplitude in a specific frequency range (a range of several kHz) of vibration occurred at the outer ring 81 increases as a whole is observed. For example, an amplitude in a frequency range three to seven times as high as the vibration frequency corresponding to the rotor rotation frequency increases as a whole. For example, when a thick portion of the lubricant oil film is present on part of the outer ring rolling surface, this frequency is substantially close to a value obtained by multiplication of a ball revolution frequency by the number of balls. In the case of an agitation loss, characteristics that the entirety of a portion in the vicinity of a frequency corresponding to such a loss rises are observed. It is assumed that this is because a location where agitation occurs is shifted or a resistance value received by each ball changes accordingly. In this case, if the temperature sensor 432 is equipped, a temperature increase is observed when the lubrication fluid increases and an agitation decrease becomes noticeable. Thus, in a case where occurrence of the vibration with a specific frequency and the temperature increase have been observed, it can be estimated that the lubrication fluid amount is excessive.

The arithmetic circuit 302 performs the above-described analysis based on measurement data of the vibration sensor 433 or measurement data of the vibration sensor 433 and the temperature sensor 432, thereby making a diagnosis on a lubrication fluid amount decrease and excess of the lubrication fluid amount. This diagnosis result is output to the drive circuit 301 and a monitoring device 1000. The drive circuit 301 having received the diagnosis result increases the amount of lubrication fluid to be supplied by the infinitesimal flow rate pump 401 in a case where the lubrication fluid amount has decreased as compared to the proper amount. Conversely, in the case of an excessive lubrication fluid amount, supply of the lubrication fluid by the infinitesimal flow rate pump 401 is decreased or stopped such that the lubrication fluid amount for the bearing 8 is adjusted to the proper amount. Alternatively, the infinitesimal flow rate pump 401 (corresponding to the infinitesimal flow rate pump 401a) and the valve 403 (corresponding to the valves 403a, 413a) are operated as in suction of FIG. 7B to adjust the lubrication fluid amount for the bearing 8 to the proper amount.

The measurement data of the vibration sensor 433 can be utilized not only for the diagnosis on the flow rate of the lubrication fluid but also for diagnosis on deterioration of the bearing 8 and determination on an increase in an unbalance amount of a rotor body. In a case where the bearing 8 has been deteriorated, a situation in which the amplitude is increased across the entire frequency and an increase in the amplitude of the frequency corresponding to the component of the deteriorated bearing 8 are observed. In a case where a scratch is caused on the rolling surface or a foreign object has entered the rolling surface, the vibration peak is often shown at a specific frequency as the function of the rotation frequency. Thus, in a case where such a vibration situation has been observed from the vibration data, the arithmetic circuit 302 outputs, to the monitoring device 1000, a warning signal for informing deterioration of the bearing 8 or a signal for informing an unbalance increase, thereby prompting the monitoring device 1000 to perform repair and maintenance. By such operation, deterioration of the bearing 8 can be properly handled, and therefore, e.g., occurrence of pump failure due to bearing deterioration can be prevented.

In a case where the lubrication fluid storage section 60 lacks the amount of stored lubrication fluid, even if the infinitesimal flow rate pump 401 is normally operated, the flow rate detected by the flow rate sensor 431 is less than a proper amount. When operation of the vacuum pump is continued in this state, occurrence of serious breakdown is predicted. Thus, the arithmetic circuit 302 makes a diagnosis on the amount of lubrication fluid stored in the lubrication fluid storage section 60 based on a detection result of the flow rate sensor 431, and outputs such a diagnosis result (i.e., the signal indicating the necessity of repair and maintenance) to the monitoring device 1000 to prompt the monitoring device 1000 to respond properly. By such operation, failure due to a lack of lubrication fluid in the lubrication fluid storage section 60 can be avoided.

As described above, in the second embodiment, the infinitesimal flow rate pump 401 is drivably controlled based on a detection result of the vibration sensor 433 (or the vibration sensor 433 and the temperature sensor 432) configured to detect vibration of the bearing 8, and in this manner, the amount of transferred lubrication fluid is controlled. Thus, the lubrication fluid amount in the bearing 8 can be maintained at the proper amount without causing an excessive or deficient state. Note that the suction operation by the infinitesimal flow rate pump 401a can be performed in the configuration including the pair of valves 403a, 413a as illustrated in FIGS. 7A and 7B. Thus, in the case of an excessive lubrication fluid amount, excessive lubrication fluid in the bearing 8 is sucked, i.e., the transfer amount is brought into a negative value, so that the lubrication fluid amount can be properly controlled.

Various embodiments and variations have been described above, but the present invention is not limited to these contents. These embodiments and variations may be combined. Other aspects conceivable within the scope of the technical idea of the present invention are also included in the scope of the present invention. For example, the turbo-molecular pump configured such that the rotor shaft of the pump rotor is supported by the bearing lubricated with the lubrication fluid has been described as the vacuum pump, but the present invention is not limited to the turbo-molecular pump. The present invention is similarly applicable to a vacuum pump configured such that a rotor shaft of a pump rotor rotating at high speed is supported by a rolling bearing lubricated with lubrication fluid.

What is claimed is:

1. A vacuum pump comprising:
a rolling bearing configured to support a rotor shaft provided at a pump rotor;
a lubrication fluid storage section configured to store lubrication fluid supplied to the rolling bearing;
a MEMS element including an infinitesimal flow rate pump configured to transfer the lubrication fluid of the lubrication fluid storage section to the rolling bearing; and
a first flow path of a capillary structure configured to move the lubrication fluid of the lubrication fluid storage section to the infinitesimal flow rate pump by capillary force.

2. The vacuum pump according to claim 1, wherein
the MEMS element is fixed to an outer peripheral surface of an outer ring of the rolling bearing, and
a second flow path formed from an outer peripheral side to an inner peripheral side of the outer ring of the rolling bearing and configured to guide the lubrication fluid sent out of the infinitesimal flow rate pump to the inner peripheral side of the outer ring is provided.

3. The vacuum pump according to claim 2, wherein
the second flow path is a through-hole penetrating from the outer peripheral surface to an inner peripheral surface of the outer ring.

4. The vacuum pump according to claim 1, wherein
the MEMS element is fixed to an outer peripheral side of a holding section configured to hold the outer ring of the rolling bearing, and
a second flow path formed from the outer peripheral side of the holding section to an inner peripheral side of the outer ring and configured to guide the lubrication fluid sent out of the infinitesimal flow rate pump to the inner peripheral side of the outer ring.

5. The vacuum pump according to claim 1, further comprising:
at least any one of a vibration sensor configured to detect vibration of the rolling bearing or a temperature sensor configured to detect a temperature of the rolling bearing; and
a control section configured to drivably control the infinitesimal flow rate pump based on a detection result of the vibration sensor or the temperature sensor, thereby controlling an amount of the lubrication fluid to be transferred by the infinitesimal flow rate pump.

6. The vacuum pump according to claim 5, further comprising:
a warning section configured to output deterioration information on the rolling bearing based on the detection result of the vibration sensor or the temperature sensor.

7. The vacuum pump according to claim 1, further comprising:
a flow rate sensor configured to detect an amount of the lubrication fluid to be transferred by the infinitesimal flow rate pump; and
a diagnosis section configured to make a diagnosis on an amount of the lubrication fluid stored in the lubrication fluid storage section based on a detection result of the flow rate sensor.
